(19) United States
(12) Patent Application Publication
(10) Pub. No.: US 2012/0330201 A1
(43) Pub. Date: Dec. 27, 2012

(54) ARTICULATED MASSAGE DEVICE

(76) Inventors: Duncan Turner, Chorleywood, Hertfordshire (GB); Christopher Glaister, London (GB)

(21) Appl. No.: 13/383,920

(22) PCT Filed: Jul. 13, 2010
(86) PCT No.: PCT/GB2010/051146

§ 371 Date: Aug. 30, 2012

(30) Foreign Application Priority Data
Jul. 13, 2009 (GB) 0912184.9

(51) Int. Cl. A61H 1/00; H02J 7/00

(52) U.S. Cl. 601/46; 320/115

(57) ABSTRACT

A massaging device having a plurality of members that are linked together such that the shape and orientation of the massaging device can be selectively changed to a desired configuration.

The present invention relates to an articulated massaging device comprising a mechanism which enables its shape and orientation to repeatedly be changed. In addition, the present invention provides a massaging device that can be locked into a chosen configuration.

There is often a desire for a person to use a massage device for recreational or therapeutic purposes. Many massage devices have been designed for this purpose, and these come in all shapes and sizes. However there is a constant need for new and improved devices that make the massage experience more pleasurable and that are able to accurately contact the desired areas with the right amount of pressure and massaging intensity which will vary for different body shapes, sizes and proportions.

A problem with existing devices is that they are often shaped generically on the assumption that one size, shape and orientation will be suitable for all. Alternatively, even if the shapes, sizes and orientations of devices vary, they are fixed for each particular device and hence a user will not necessarily know which is the best device for them when initially selecting such a device and therefore may have to purchase a number of devices before finding the best one for them.

The present invention provides a massaging device having a mechanism comprising a plurality of members that are linked together such that the shape and orientation of the massaging device can be selectively changed to a desired configuration.

The present invention therefore provides an advantage over existing devices in that its shape and orientation may be easily changed by a user so that they may select the shape and orientation of the massaging device that best suits them. A further benefit is that if a user's massage needs change, the device can easily be reconfigured to suit those needs, thereby removing the need to have a different device for each desired configuration.

The present invention further comprises an optional alternative tip arrangement that is not connected to the mechanism and can therefore be freely orientated. This tip arrangement further comprises a tip locking mechanism to retain the tip once in a chosen orientation.

The mechanism is arranged to fit inside a flexible outer covering to form the massage device. This flexible outer can be moulded ‘inside out’ prior to assembly to remove any part lines from manufacturing being visible on the mechanism once covered.

The present invention further comprises two different locking mechanisms, for allowing the curl of the device to be changed and then locked into position once a desired curl has been selected. This adjustability could also be achieved by a plurality of independently lockable mechanisms, configured to be adjusted independently from the mechanism described before to adjust the massage device.

The present invention further comprises a connection means for charging a battery incorporated into a vibrating module provided as part of the massaging device, the connection means comprising a battery cover having control buttons configured to increase or decrease the amount of vibration, wherein the control buttons also function as positive and negative contacts for charging the battery.

An exemplary device according to the present invention will now be described with reference to the following figures, in which:

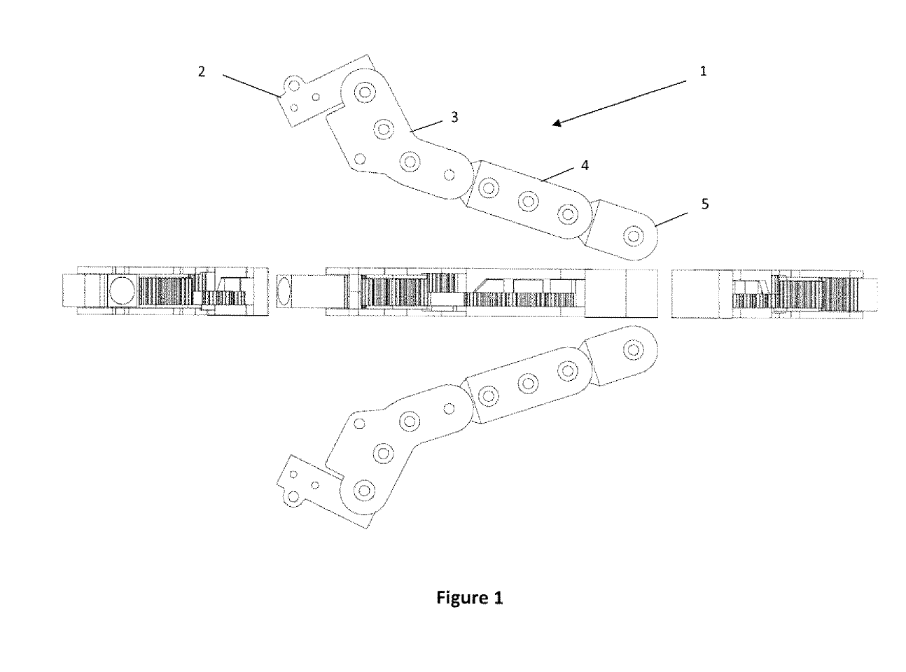

FIG. 1 shows the internal mechanism of the exemplary device;

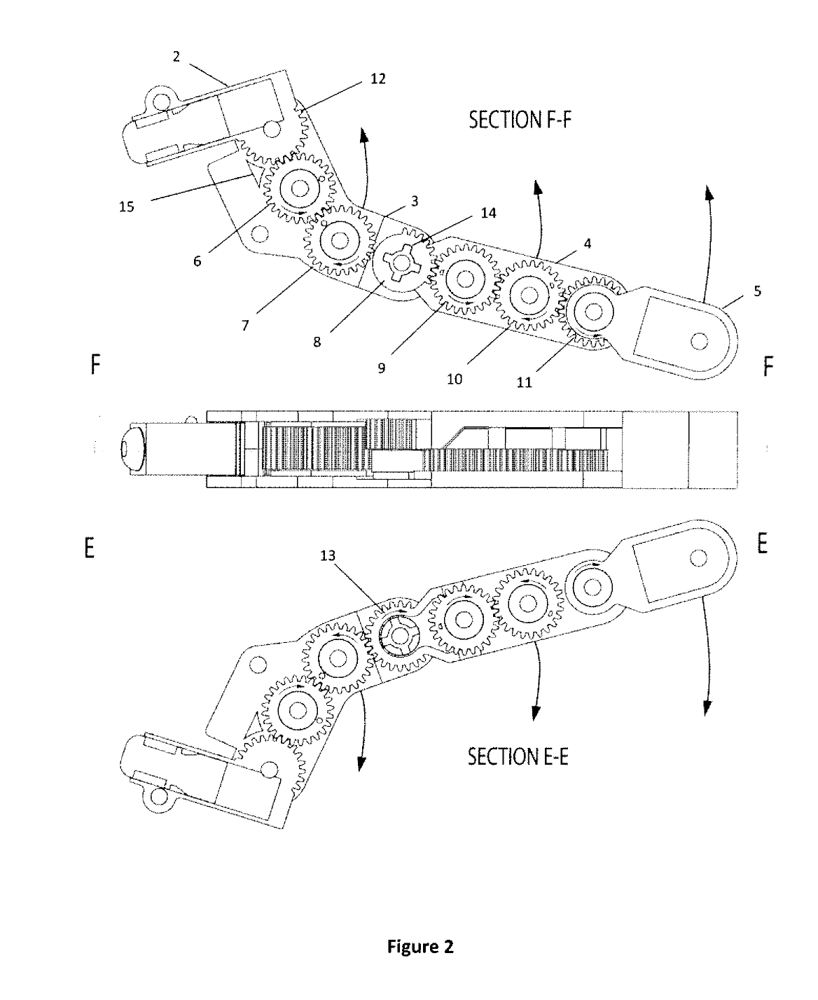

FIGS. 2(a) and 2(c) show section views of either side of the mechanism shown in FIG. 1 and FIG. 2(b) shows an underside view;

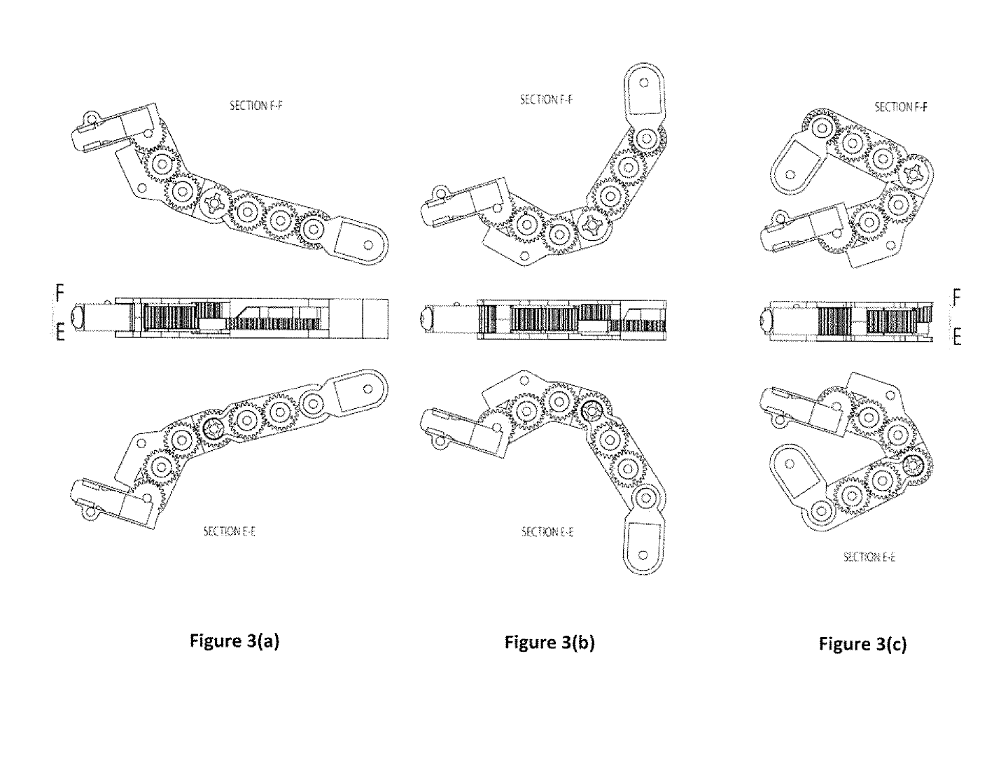

FIGS. 3(a), (b) and (c) show an exemplary curling sequence of the mechanism;

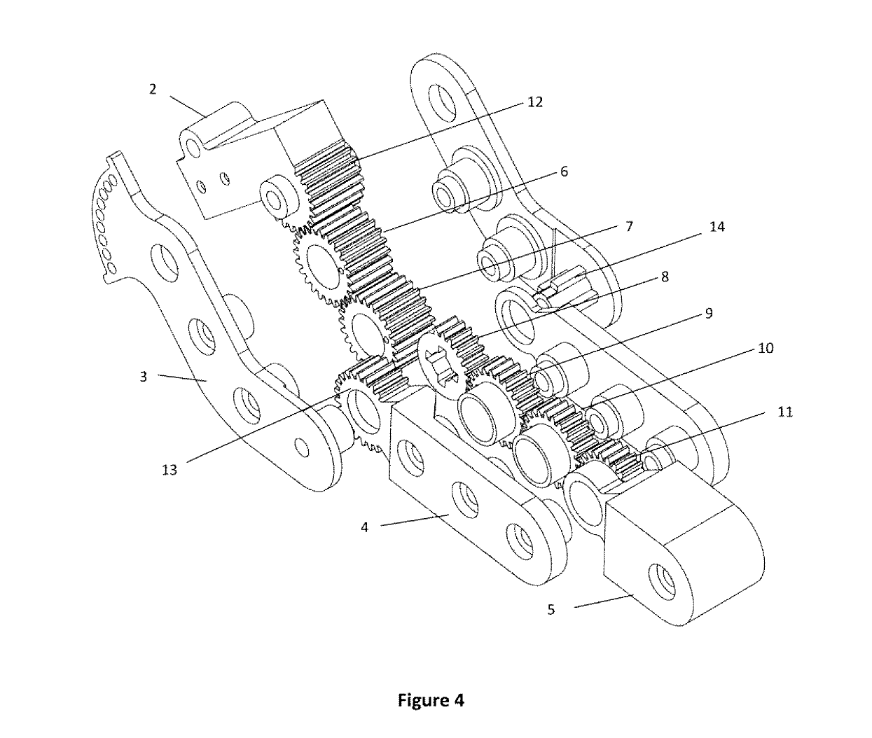

FIG. 4 shows an exploded view of the mechanism;

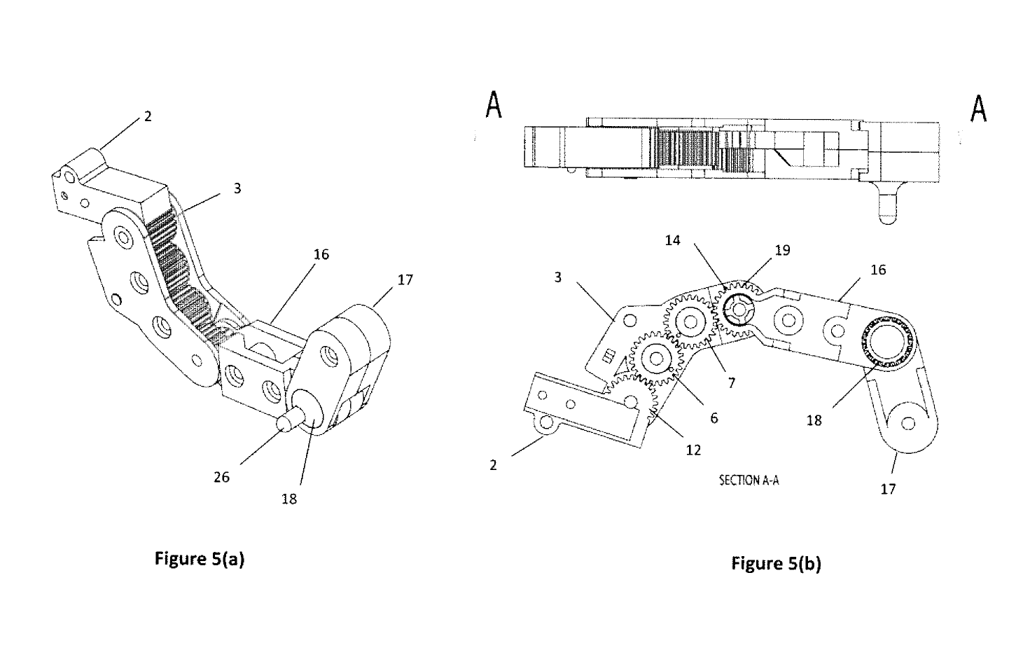

FIG. 5 shows an overview and section view of an alternative tip lock mechanism;

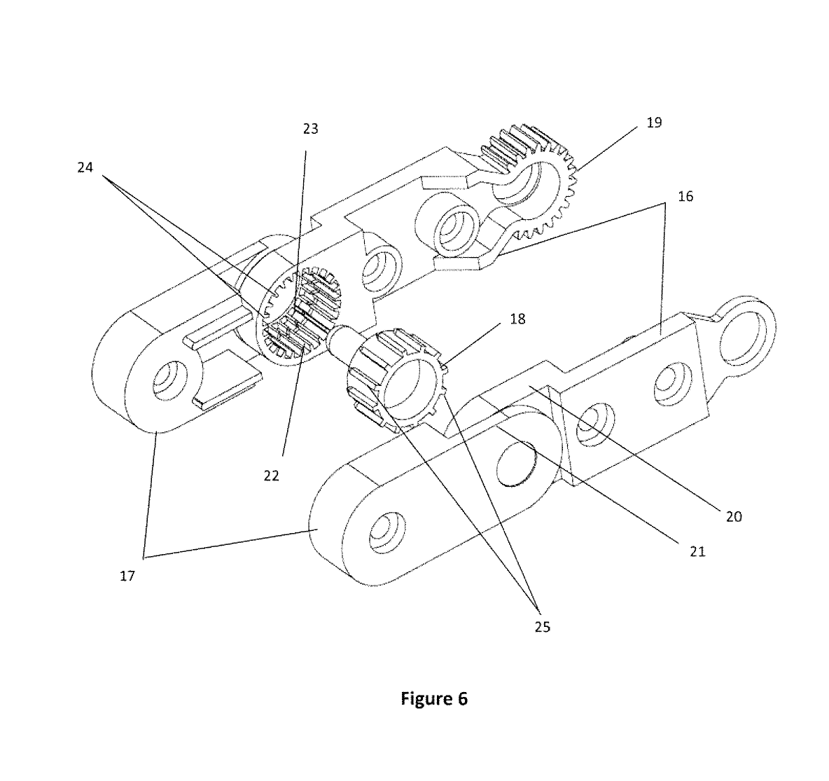

FIG. 6 shows an exploded view of the tip lock mechanism of FIG. 5

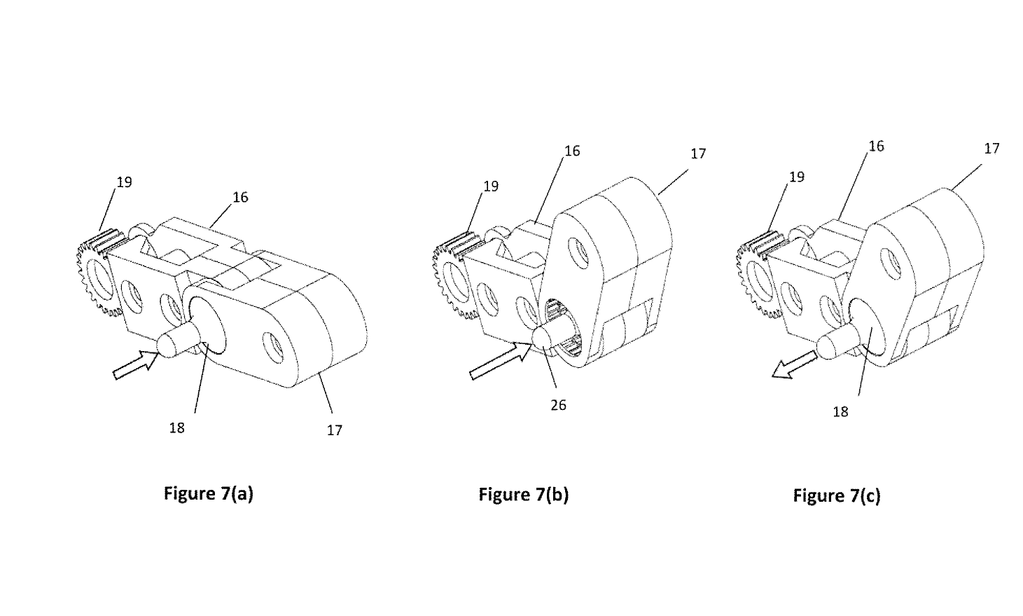

FIGS. 7(a), (b) and (c) show the operation of the tip lock mechanism shown in FIG. 5;

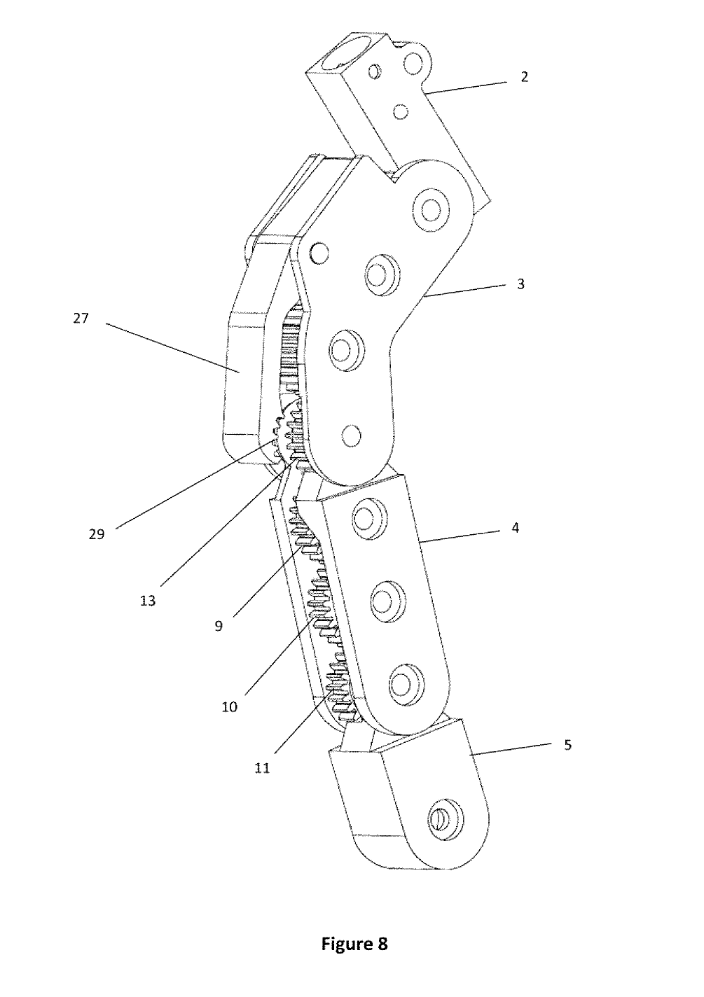

FIG. 8 shows an overview of a gear locking mechanism;

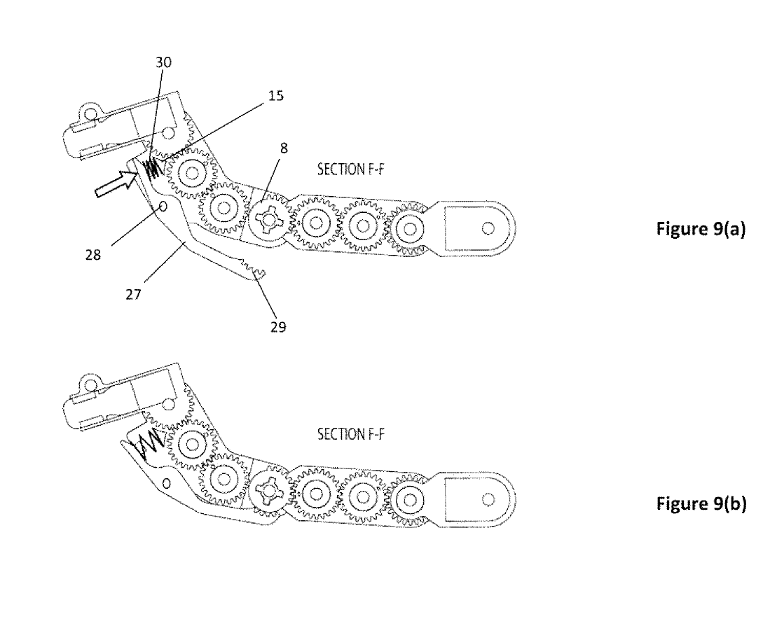

FIGS. 9(a) and (b) show section views of the mechanism having the gear locking mechanism of FIG. 8 disengaged and engaged, respectively;

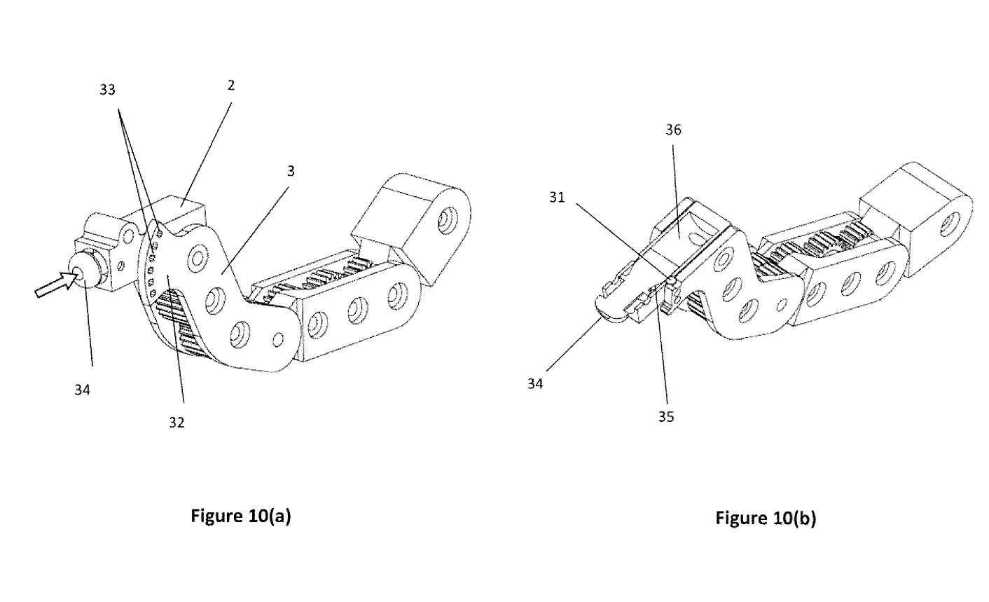

FIG. 10 shows an alternative gear locking mechanism;

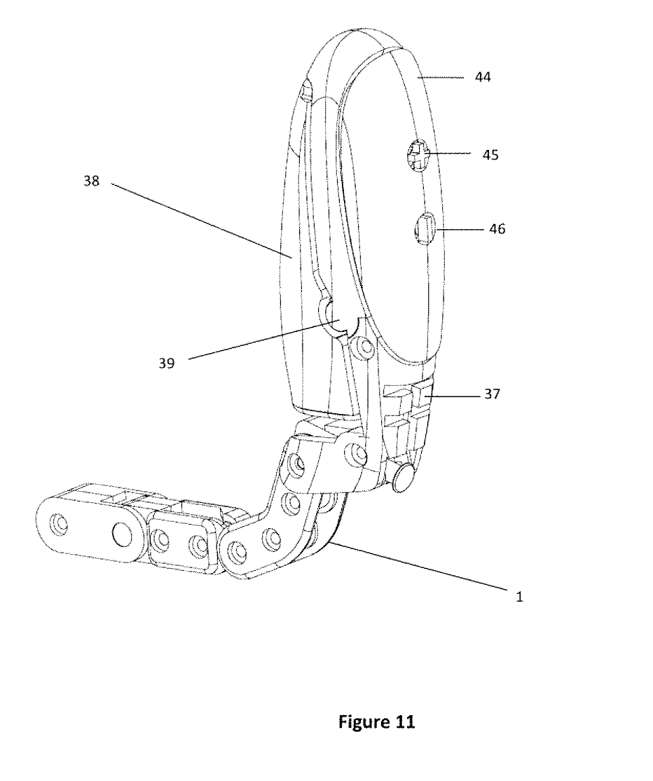

FIG. 11 shows a vibration module attached to the mechanism;

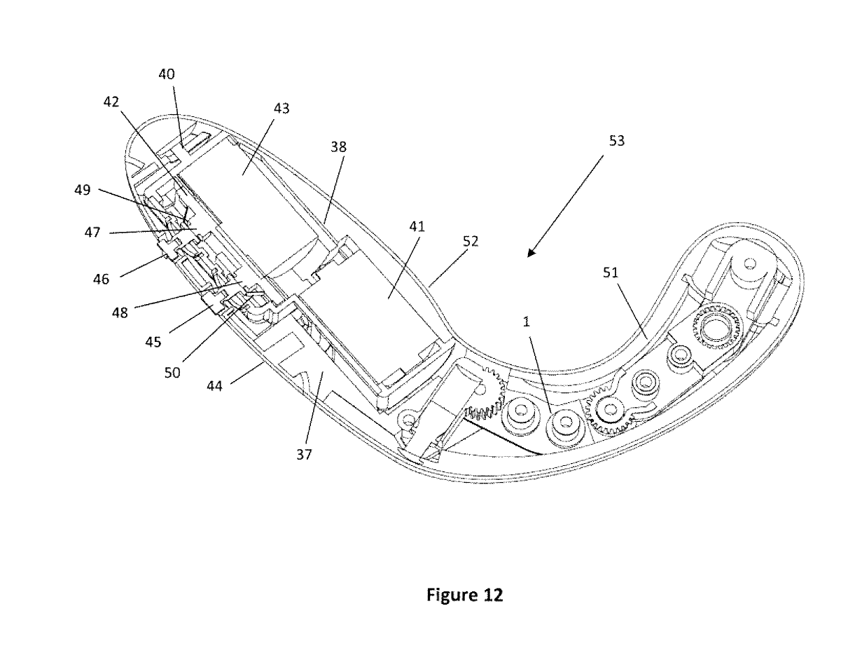

FIG. 12 shows a section view of the exemplary massage device depicting the various components;

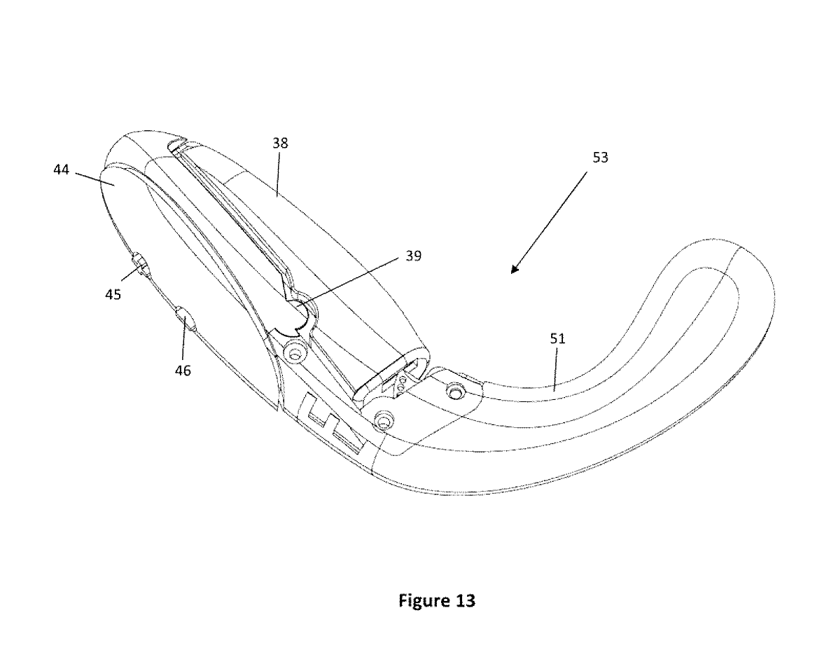

FIG. 13 shows the exemplary massage device with the mechanism encased within a padded silicone sock; and

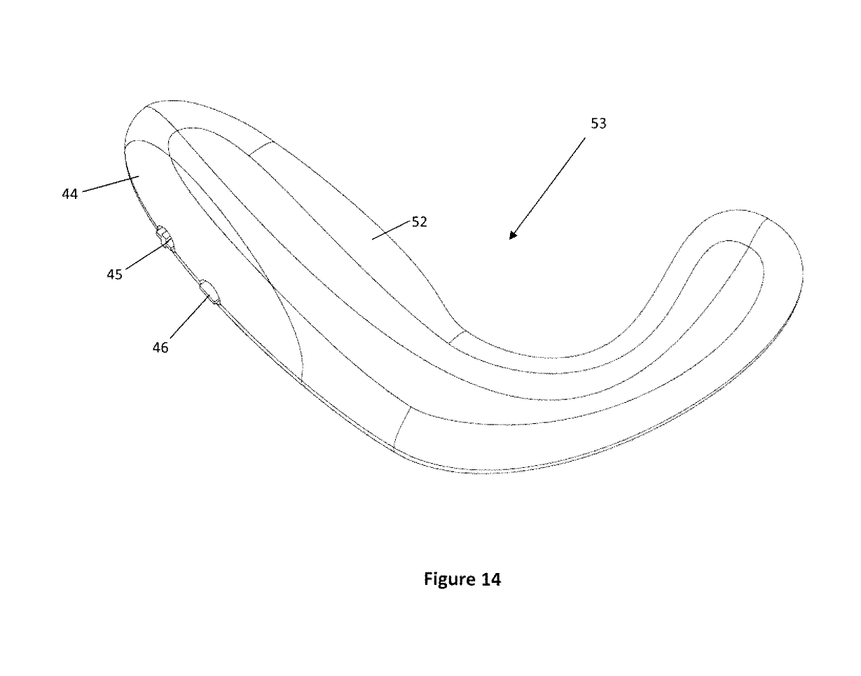

FIG. 14 shows an overview of the exemplary massage device with the mechanism and vibrating module fully encapsulated within a silicone outer moulding.

FIG. 1 shows the internal skeleton structure 1 of an exemplary articulated massage device according to the present invention, in which the skeleton structure 1 comprises a plurality of members 2, 3, 4, 5 that are pivotally linked together to form a finger-like mechanism 1, wherein the members 2, 3, 4, 5 are rotatably movable relative to one another. However, the movement of the members 2, 3, 4, 5 and hence device, is limited by a plurality of gears 6, 7, 8, 9, 10 that form a gear train which is configured to ensure that the movement of the members 2, 3, 4, 5 relative to each other is controlled such that shape of the device can only be reconfigured to follow a predetermined curling sequence, as will be described further on. Although in this example the members are linked together using a plurality of gears, they could, of course, alternatively be linked together using toothless gears, pulleys, chain and sprockets, or similar.

FIGS. 2(a) and 2(c) show section views of the mechanism 1 taken from either side, with the gear train exposed. The curl of the mechanism can be changed according to a predetermined curl sequence, which is controlled by the gear train, as follows. While the base member 2 is held stationary, a force F is applied to tip member 5, which rotates anti-clockwise about its axis where it is linked to upper member 4. Cogs 11 on the tip member 5 engage the fifth gear wheel 10 and drive it clockwise. The fifth gear wheel 10, in turn, drives the fourth gear wheel 9 in an anti-clockwise direction. Third gear wheel 8 is fixed to lower member 3 by means of a spline 14, as can be seen in FIG. 2(a) and therefore the rotation of the fourth gear wheel 9 causes the upper member 4 to rotate anti-clockwise relative to the lower member 3 about the axis where they are pivotally linked.

As shown in FIG. 2(c), as the upper member 4 rotates, fixed cogs 13 provided at the end linked to lower member 3 engage with the second gear wheel 7, driving it clockwise. The second gear wheel 7, in turn, engages the first gear wheel 6, causing it to rotate anti-clockwise and drive against the fixed base cogs 12 of the base member 2. Since the base member 2 is held stationary, the resultant pivotal force causes lower member 3 to rotate anti-clockwise relative to the base member 2. FIG. 2(b) is an underside view of the device, showing the arrangement of the gear train and the fixed cogs 13 provided at the end of the upper member 4.

All of the above movements happen simultaneously with the result that the mechanism 1 curls up following a predetermined curl sequence, as shown in FIGS. 3(a), (b) and (c).

Of course, if force F is reversed, the mechanism 1 will uncurl in reverse order to the steps described above. Furthermore, a skilled person will recognise that any of the four members 2, 3, 4, 5 can be held stationary whilst a force is applied to any of the other members 2, 3, 4, 5 in a direction perpendicular to its pivots, to cause the mechanism 1 to change shape.

FIG. 4 is an exploded view of the exemplary mechanism 1 showing how all the members 2, 3, 4, 5 and gear train are joined together within the mechanism 1. In particular, it can clearly be seen how the tip member 5 is configured to rotate in relation to upper member 4 as a result of the third gear wheel 8 being splined 14 to the lower member 3 and, furthermore, how the fixed cogs 13 provided at the end of the upper member 4 engage with the second gear wheel 7, thereby causing the upper member 4 to rotate relative to the lower member 3.

An alternate exemplary arrangement provided by the present invention involves substituting the upper member 4 and the tip member 5 of the mechanism 1 with replacement upper member 16 and independent tip member 17, respectively, as shown in FIG. 5(a). In this arrangement, the tip member 17 can be orientated independently of the mechanism 1 as it is not connected to the gear train. A retractable button 18 forms part of a tip lock mechanism, which is used to releasably secure independent tip member 17 in a chosen position. This alternative arrangement gives more control of the shape of the device to the user.

As shown in FIG. 5(b), the replacement upper member 16 is connected to lower member 3 by fixed cogs 19, similar to the fixed cogs 13 of the previous arrangement. However, with this arrangement, there is no gear wheel splined to the lower member 3 as this is no longer required since the tip can be independently orientated. Indeed, as can be seen, there are no gear wheels provided in replacement upper member 16 in this arrangement.

As shown in FIG. 6, the independent tip member 17 overlaps the replacement upper member 16 on either side of the mechanism 1. On one side of the mechanism 1, the independent tip member 17 is pivotally linked to the replacement upper member 16 where they overlap. On the opposite side of the mechanism 1, the overlapping ends 20, 21 of the independent tip member 17 and the replacement upper member 16 are each provided with corresponding through-holes 22, 23, which are arranged to be aligned together. Both of the through-holes 22, 23 have corresponding grooves 24 cut into them, the grooves 24 of each through-hole 22, 23 being configured such that for certain degrees of rotation of the independent tip member 17 relative to the replacement upper member 16 the grooves 24 of both through-holes 22, 23 are aligned.

A locking button 18 is arranged to be received by the through-holes 22, 23, the button 18 being biased against the opposite, pivotally connected, side of the replacement upper member 16 such that after the button 18 has been depressed it will return to its original position. The button 18 has splines 25 on its outer circumferential surface that are configured to match the grooves 24 of the through-holes 22, 23. This enables the button 18 to fit through both of the through-holes 22, 24 when the grooves 24 are aligned, thereby preventing relative rotational movement of the members 16, 17. When the button 18 is depressed, the members 16, 17 are able to rotate relative to one another. The button 18 has a projection 26 which helps it to be located.

The operation of the tip lock mechanism can be seen in FIGS. 7(a) to (c), where in FIG. 7(a) the mechanism is in a straight configuration. The button is depressed in FIG. 7(b) to allow the tip member 17 to rotate relative to the upper member 16 and the tip 17 is moved to a different position. In FIG. 7(c) the button is released, whereby it is biased, preferably by a coil spring (not shown), back into its securing position within the through-holes of the members 16, 17 and the tip 17 is thus secured in its new position.

Of course, a skilled person will recognised that this independent member and button locking arrangement could also be employed at any of the other knuckle-like connections between the different members 2, 3, 4, 5 with the same effect. Furthermore, a skilled person will recognise that the more members 2, 3, 4, 5 featured in the mechanism 1, the greater the degree of curling can be controlled. In addition, a skilled person will understand that the more grooves 24 and splines 25 that are provided on the through-holes 22, 23 and button 18, respectively, the more precise the selection of a desired orientation can be.

FIG. 8 shows an exemplary gear locking mechanism of the present invention, wherein a locking lever 27 is pivotally attached 28 to lower member 3. The lever has locking teeth 29 provided on an inside surface which are engageable with the fixed cogs 13 provided on the end of upper member 4 to prevent it rotating relative to lower member 3.

This can be seen even more clearly in FIGS. 9(a) and (b), which show a gear locking lever 27 that is biased against a stop 15, provided on lower member 3, to engage with the fixed cogs 13 of upper member 4 (or the fixed cogs 19 of replacement upper member 16), thereby effectively locking the whole mechanism 1 into the chosen orientation. By releasing the locking lever 27, the locking teeth 29 can be disengaged from the fixed cogs 13, 19 on the upper member 4, 16 to allow the orientation of the mechanism 1 to be altered. In this way the curl of the mechanism 1 can be set and locked repeatedly. Preferably, a coil spring 30 returns the locking lever 27 to the biased, locked position, although other suitable biasing means are, of course, possible.

Furthermore, it will be understood that the locking lever could alternatively be designed to interface with any of the gear wheels 6, 7, 8, 9, 10 for example the first gear 6, or the second gear 7, or even a combination of gear wheels, to give the same locking action.

An alternative locking mechanism that could be used with the present invention is shown in FIGS. 10(a) and (b), wherein the lower member 3 is lockable relative to the base member 2 by way of a ball bearing 31. FIG. 10(a) shows the lower member 3 having an extended portion 32 provided on one side, the extended portion 32 having a plurality of locking dimples 33 provided along its edge.

As can be seen from FIG. 10(b), the ball bearing 31 is held across an interface between the extended portion 32 of the lower member 3 and the base member 2. When in a locked position, the ball bearing 31 rests in one of the locking dimples 33, which are smaller in diameter than the ball bearing 31 and therefore hold the ball bearing 31 in such a way that it straddles the gap between the lower member 3 and the base member 2, thereby preventing any relative motion between the two members 2, 3.

A button 34 having a tapered portion 35 is biased against the base member 2 such that when the button 34 is depressed, the taper 35 on the button 34 allows the ball bearing 31 to move away from the locking dimples 33, thereby allowing the lower member 3 to rotate relative to the base member 2. When the button 34 is released it returns to its starting position thanks to, preferably, a coil spring (not shown) positioned in a void 36 located in the base member 2. The taper 35 on the button 34 forces the bail bearing 31 back against the extended portion 32 of the lower member 3.

If the ball bearing 31 is not immediately aligned with a locking dimple 33, it will jump into the nearest locking dimple 33 when the mechanism 1 is rotated, thereby locking the mechanism 1. The button 34 then continues back to its starting position. Once returned to its starting position, the parallel sides surfaces of the button 34 ensures that forcing the mechanism 1 to move cannot cause the button 34 to move and disengage the ball bearing 31.

FIG. 11 shows a support chassis 37 attached to the base member 2 of the mechanism 1 for the installation of a vibration module 38. The vibration module 38 is, ideally, waterproof and is, preferably, suspended in the support chassis 37 by three vibration isolation mounts 39, 40 comprising two lateral mounts 39 and one top mount 40. The mounts 39, 40 act to reduce the vibration that is transmitted to the support chassis 37 which is, generally, in contact with a user's hand.

FIG. 12 shows a section view of the mechanism 1 and vibration module 38 encased within an outer silicone moulding 52, which encompasses all of the above components, to form the exemplary articulated massage device 53 of the present invention. As can also be seen in this figure, the vibration module 38 comprises a vibration motor 41, circuitry (PCB) 42 for controlling the motor 41, and a secondary battery 43. The vibration module 38 is sealed by a plastic fascia 44, which is provided with control buttons 45, 46, configured to selectively “increase” 45 or “decrease” 46 the speed of the motor 41 and hence the intensity of vibration.

The control buttons 45, 46 are constructed from an electrically conductive material, for example aluminium. When depressed, the control buttons 45, 46 in turn depress surface mount technology (SMT) push buttons 47, 48 on the PCB 42. In between the control buttons 45, 46 and the SMT push buttons 47, 48 are sprung metal contacts 49, 50 which are connected to the PCB 42. These metal contacts 49, 50 electrically connect the external metal control buttons 45, 46 to the PCB 42, thereby facilitating charging through the control buttons 45, 46 via an external connector (not shown).

This arrangement negates the need for a separate charger and, furthermore, enables the vibration module 38 to be more easily and effectively waterproofed. External connecters for charging (not shown) are attachable to the control buttons 45, 46, and hence the outside of the massage device 53, using, for example, magnets. Alternatively, the massage device 53 may be placed in a cradle having electrical contacts arranged to align with the control buttons 45, 46.

Other electronic devices such as, for example, mobile phones, portable music or video devices, personal organisers, computers, or indeed any electronic device that has a rechargeable battery could similarly benefit from an arrangement wherein the rechargeable battery is charged via the one or more control buttons of the device, as described above.

Indeed, a charging system might incorporate an electronic device as described above and a charging cradle arranged to receive the electronic device in such a way that the rechargeable battery can be charged via the one or more control buttons.

FIG. 13 shows the massage device 53 without the outer silicone moulding 52. The mechanism 1 is encased within a flexible padded silicone sock 51 comprising a flexible material, preferably having a flesh-like texture and density, which acts to bulk out the mechanism 1 such that the silicone sock 51 provides a smooth shape around it.

FIG. 14 shows an external view of the exemplary articulated massage device 53 according to the present invention. It can be seen that an outer silicone moulding 52 encases all of the components of the massage device and that the plastic fascia 44, comprising the control (and battery charging) buttons 45, 46, acts to seal the vibration module 28 within the outer silicone moulding 52 and prevent the ingress of fluids. This outer silicone moulding 52 is, preferably, moulded inside out to prevent any manufacturing part lines being visible on the final assembled device.

1. A massaging device having a mechanism comprising a plurality of members that are linked together such that the shape and orientation of the massaging device can be selectively changed to a desired configuration.

2. The device of claim 1, wherein the mechanism is configured such that the shape and orientation of the massaging device follows a predetermined curl sequence.

3. The device of claim 1, wherein the mechanism comprises one or more linkages configured to allow the shape and orientation of the massaging to be user-adjusted.

4. The device of claim 3, wherein the mechanism is provided with releasable locking means for retaining the massaging device in a desired configuration.

5. The device of claim 1, wherein the mechanism ends in a tip that is arranged to be adjustable in relation to the mechanism.

6. The device of claim 5, wherein the tip is provided with a releasable locking means to retain the tip in a desired adjustment position.

7. The device of claim 6, further comprising a handle portion provided at an end of the mechanism.

8. The device of claim 7, wherein the handle portion includes a control module, comprising:
a rechargeable battery;
vibrating means arranged to be powered by the rechargeable battery; and
at least one control button for controlling the intensity of the vibrating means.

9. The device of claim 8, wherein the at least one control button is arranged to connect to a separate power supply for charging the rechargeable battery.

10. The device of claim 8, wherein the control module is removable from the handle portion.

11. The device of claim 5, wherein the mechanism is covered by a flexible outer skin.

12. The device of claim 11, wherein the flexible outer skin is moulded inside out to remove any manufacturing part lines from being visible on the skin when covering the mechanism.

13. The device of claim 12, wherein the releasable locking means comprises a release button that is hidden under the flexible outer skin.

14. (canceled)

15. A charging system comprising:
an electronic device including
one or more control buttons, and
a rechargeable battery arranged to be charged via the one or more control buttons; and
a charging cradle arranged to receive the electronic device such that the rechargeable battery can be charged via the one or more control buttons.

16. A method for charging a rechargeable battery in an electronic device having one or more control buttons, comprising the step of providing a current through the one or more control buttons, wherein the one or more control buttons are arranged as electrical contacts for charging the rechargeable battery.
